(19) United States
(12) Patent Application Publication
(10) Pub. No.: US 2024/0103264 A1
(43) Pub. Date: Mar. 28, 2024

(54) OPTICAL DEFLECTOR, SCANNING OPTICAL DEVICE, AND IMAGE FORMING APPARATUS

(71) Applicant: CANON KABUSHIKI KAISHA, Tokyo (JP)

(72) Inventors: NAOKI MATSUSHITA, Shizuoka (JP); Takatoshi Tanaka, Shizuoka (JP); YOSHIHIKO TANAKA, Shizuoka (JP)

(21) Appl. No.: 18/358,292

(22) Filed: Jul. 25, 2023

(30) Foreign Application Priority Data
Sep. 22, 2022 (JP) 2022-151927

(51) Int. Cl. G02B 26/12; G03G 15/043

(52) U.S. Cl. CPC G02B 26/121; G03G 15/0435

(57) ABSTRACT

An optical deflector includes a rotatable polygon mirror and an urging member to urge the rotatable polygon mirror toward a driving unit to fix the rotatable polygon mirror to the driving unit. The urging member includes an annular shape portion having an annular shape surface contacting the rotatable polygon mirror and a plurality of arm portions integrally formed with the annular shape portion. The plurality of the arm portions radially extend from an outer circumference of the annular shape portion, are disposed at equal intervals with respect to a rotational direction with a rotation center of the rotatable polygon mirror, and are pressed by a restricting member.

### FIELD OF THE INVENTION AND RELATED ART

The present invention relates to an optical deflector, a scanning optical device and an image forming apparatus, for example, a scanning optical device which includes an optical deflector for scanning a laser light onto an image bearing member and an image forming apparatus which uses the scanning optical device.

Conventional scanning optical devices which are used in image forming apparatuses such as laser printers modulate a laser light which is emitted from a light source according to an image signal, and the modulated laser light is deflected and scanned by an optical deflector which includes a rotatable polygon mirror, for example. The deflected and scanned laser light is formed on a photosensitive drum by a scanning lens such as an fθ lens and form an electrostatic latent image. Next, the image forming apparatus develops the electrostatic latent image on the photosensitive drum into a toner image by a developing device, transfers the toner image to a recording material and conveys it to a fixing device, and performs print by heating and fixing the toner on the recording material. Conventionally, an optical deflector is configured of a rotatable polygon mirror, a rotor, a rotating shaft which is integrated with the rotor and a pedestal for installing the rotatable polygon mirror, a bearing sleeve which is integrated with a board, and a stator. And the rotatable polygon mirror is fixed to the pedestal by an urging member such as a spring, while the rotatable polygon mirror is pressed against the pedestal. The urging member is used to fix the rotatable polygon mirror to the pedestal in a precisely and stably.

When each reflecting surface of the rotatable polygon mirror deforms differently by receiving urging force from the spring and frictional force between the spring and the rotatable polygon mirror, jitter and surface inclination is occurred and an image defect may be occurred since difference of reflecting surface accuracy among the reflecting surfaces may be increased. On the other hand, when the urging force of the spring is reduced in order to suppress the deformation of each reflecting surface, the rotatable polygon mirror may be deviated from the pedestal during motor rotation, for example, since the rotatable polygon mirror is not properly fixed to the pedestal. In such cases, an image defect may be occurred since jitter is increased. In order to suppress these problems, it is desirable that the rotatable polygon mirror is securely fixed to the pedestal while the difference of the reflecting surface accuracy among the reflecting surfaces is reduced by distributing the urging force of the spring evenly to the rotatable polygon mirror. For example, in Japanese Laid-Open Patent Application (JP-A) Hei 08-171067, it is configured so that frictional force between the spring and the rotatable polygon mirror hardly occurs since the spring whose cross section is U-shaped is used and the urging force of the spring acts in a direction of a rotational axis of a motor.

However, in the conventional example, the spring is provided in an opening portion for mounting the spring in a radial direction of the rotational axis, so the urging force hardly acts evenly on the rotatable polygon mirror. Therefore, the rotatable polygon mirror may be distorted, and the difference of the reflecting surface accuracy among the reflecting surfaces may be increased since a deformation amount of each reflecting surface is different.

In response to the above issue, it is an object of the present invention is to fix the rotatable polygon mirror more accurately and more stably to the pedestal and to suppress occurring the jitter, the surface inclination, etc.

### SUMMARY OF THE INVENTION

In response to the above issue, the present invention includes the following configuration. According to an aspect of the present invention, there is provide an optical deflector comprising, a rotatable polygon mirror including a plurality of reflecting surfaces for reflecting light, a driving unit configured to drive the rotatable polygon mirror, an urging member configured to urge the rotatable polygon mirror toward the driving unit to fix the rotatable polygon mirror to the driving unit and a restricting member configured to press the urging member and restrict movement of the urging member with respect to a rotational axis direction of the rotatable polygon mirror, wherein the urging member includes an annular shape portion having an annular shape surface contacting the rotatable polygon mirror and a plurality of arm portions integrally formed with the annular shape portion, and wherein the plurality of the arm portions radially extend from an outer circumference of the annular shape portion, are disposed at equal intervals with respect to a rotational direction with a rotation center of the rotatable polygon mirror, and are pressed by the restricting member.

Further features of the present invention will become apparent from the following description of exemplary embodiments with reference to the attached drawings.

### BRIEF DESCRIPTION OF THE DRAWINGS

FIG. 1 is a schematic sectional view showing an image forming apparatus according to a first embodiment and a second embodiment.

FIG. 2 is a perspective view of an optical deflector and a scanning optical device according to the first embodiment and the second embodiment.

FIG. 3 is a sectional view which includes a center of rotation of a deflector according to the first embodiment.

Part (a) and part (b) of FIG. 4 are a top view and a side view of a spring according to the first embodiment.

FIG. 5 is a side view of a fixing portion of a rotatable polygon mirror of the deflector according to the first embodiment.

Part (a) of FIG. 6 is a perspective view of the spring and part (b) of FIG. 6 is a side view of the fixing portion of the rotatable polygon mirror of the deflector, showing a modified example according to the first embodiment.

Part (a) of FIG. 7 is a perspective view of the spring and part (b) of FIG. 7 is a perspective view of the rotatable polygon mirror according to the second embodiment.

Part (a) of FIG. 8 is a perspective view of the fixing portion of the rotatable polygon mirror of the deflector and part (b) of FIG. 8 is a diagram showing one of four equal areas of a stress distribution when it is seen from a bottom surface side of the spring according to the second embodiment.

### DESCRIPTION OF THE EMBODIMENTS

An image forming apparatus which is provided with a scanning optical device according to an embodiment of the present invention will be described. In the following, at first, an image forming apparatus which is provided with a scanning optical device according to the present invention will be described, and then, a scanning optical device in the image forming apparatus will be described. Subsequently, a deflector, which is an optical deflector to be mounted on the scanning optical device, will be described. Incidentally, dimensions, materials, shapes, and relative arrangements, etc. of component parts which are described in the following embodiments are not intended to limit scope of the present invention to them alone, unless they are specifically described in particular.

### First Embodiment

### [Image Forming Apparatus]

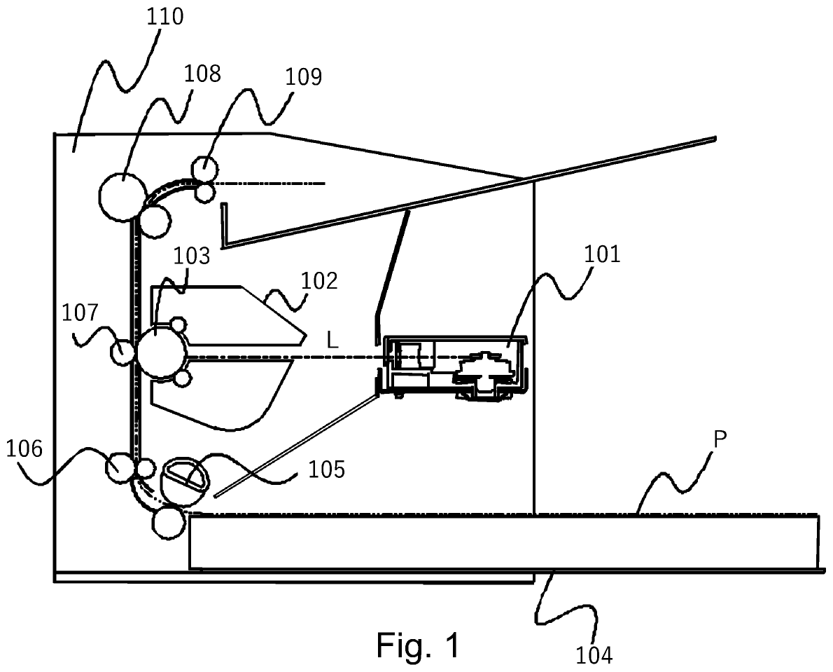

FIG. 1 is a schematic sectional view showing the image forming apparatus according to the first embodiment. An image forming apparatus 110 includes a scanning optical device 101. The image forming apparatus 110 is provided with an image forming means which scans on a photosensitive drum 103 (on an image bearing member) which is an image bearing member by the scanning optical device 101 and performs image forming on a recording material such as a recording paper P based on the scanned image. Here, a printer is used as an example of an image forming apparatus.

The image forming apparatus 110 emits a laser light L based on the obtained image information from the scanning optical device 101 which is an exposure means, and irradiates it onto the photosensitive drum 103 which is incorporated in a process cartridge 102. A latent image (electrostatic latent image) is formed on the photosensitive drum 103, and the latent image is developed into a toner image using toner as a developer by the process cartridge 102. Incidentally, the process cartridge 102 includes integrally the photosensitive drum 103 and a charging means, a developing means, etc. which is a process means which acts on the photosensitive drum 103.

On the other hand, the recording paper P which is stacked on a stacking plate 104 is fed to a conveying passage while the recording paper P is separated one sheet by one sheet by a feeding roller 105. The recording paper P is conveyed to a further downstream side with respect to a conveying direction by an intermediary roller 106. On the fed recording paper P, the toner image formed on the photosensitive drum 103 is transferred by the transfer roller 107. The recording paper P on which the unfixed toner image is formed is conveyed to a further downstream side, and the toner image is fixed to the recording paper P by a fixing device 108 which includes a heating member inside. After that, the recording paper P is discharged from the apparatus by a discharging roller 109.

Incidentally, in the first embodiment, a charging means and a developing means as process means which act on the photosensitive drum 103 are included integrally with the photosensitive drum 103 in the process cartridge 102, however, each process means may be configured separately from the photosensitive drum 103. Further, in FIG. 1, the image forming apparatus which includes a single process cartridge is described, however, it may be an image forming apparatus which includes a plurality of process cartridges or a plurality of scanning optical devices 101.

### [Scanning Optical Device]

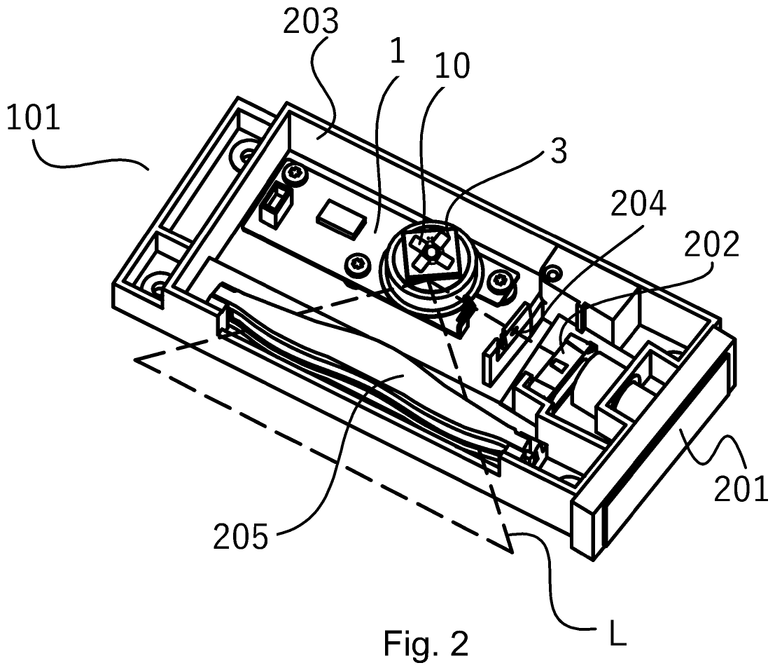

The scanning optical device 101, in which the image forming apparatus 110 includes, will be described by using FIG. 2. FIG. 2 is a perspective view showing a configuration of the scanning optical device 101 according to the first embodiment. The laser light L which is emitted from a light source 201 is condensed in a sub scanning direction by a cylindrical lens 202 and limited to a predetermined light diameter by an optical diaphragm 204 which is formed in a casing 203. The laser light L is deflected by a rotatable polygon mirror 3 which is rotatably driven by a motor, and after passing through an fθ lens 205, it is converged and scanned on the photosensitive drum 103, not shown in FIG. 2, and an electrostatic latent image is formed.

Incidentally, the light source 201, the cylindrical lens 202, a deflector 1, etc. are accommodated in the casing 203, and an opening portion of the casing 203 is closed by a plastic or metal optical cover (not shown). Further, the rotatable polygon mirror 3 according to the first embodiment includes four reflecting surfaces which are reflecting surfaces which reflect the laser light L and are parallel to a direction of a rotational axis of the rotatable polygon mirror.

### [Deflector]

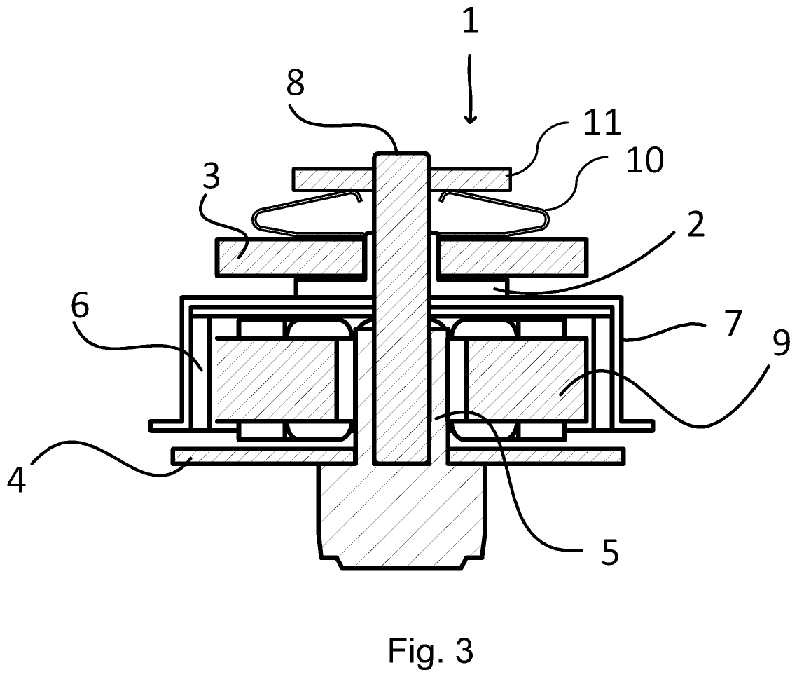

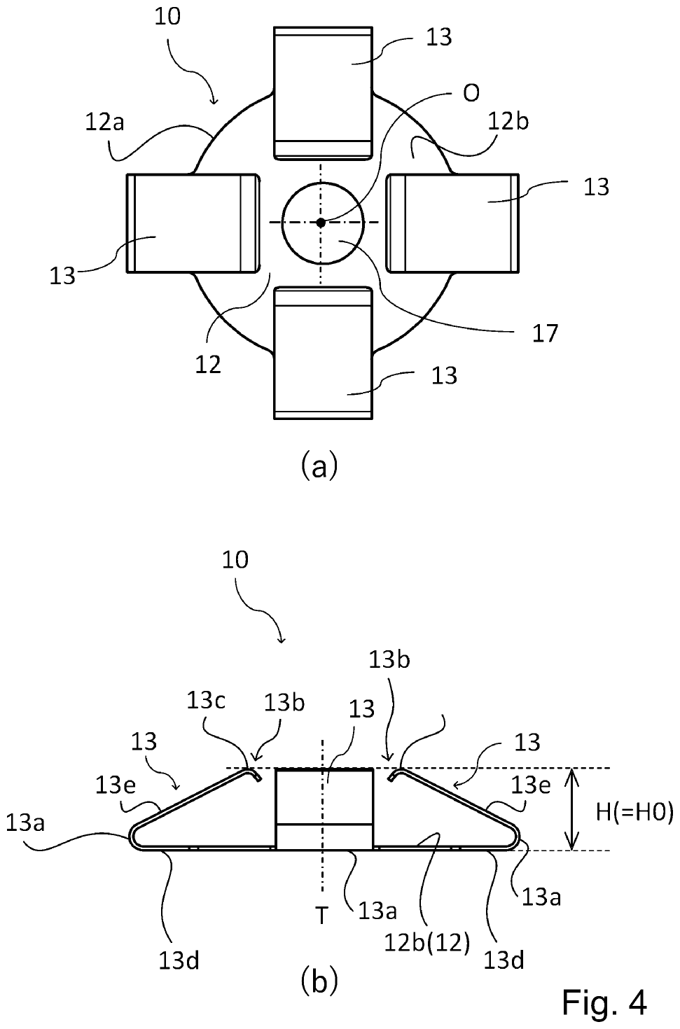

The deflector 1 will be described by using FIG. 3. FIG. 3 is a sectional view including a rotational center of the deflector 1. In the deflector 1, the rotatable polygon mirror 3 is mounted on a motor which is configured of a bearing sleeve 5, a rotor 7, a rotating shaft 8, a pedestal 2 and a stator coil 9. The rotatable polygon mirror 3 deflects the laser light L which is not shown in FIG. 3. The bearing sleeve 5 is supported by a board 4 which is configured of a metal plate. The rotor 7 includes a rotor magnet 6. The rotating shaft 8 and the pedestal 2 are integral with the rotor 7. The stator coil 9 is fixed to the board 4. The rotor 7, the rotating shaft 8 and the stator coil 9 configure a motor which is a driving means which rotationally drives the rotatable polygon mirror 3. The rotatable polygon mirror 3 is made of metal or resin, for example, and is fixed to the pedestal 2 by a spring 10, which is an urging member, and a restricting member 11 such as a snap ring which restricts a movement of the spring 10 with respect to a direction of the rotational axis of the spring 10. The spring 10 fixes the rotatable polygon mirror 3 to the motor by urging the rotatable polygon mirror 3. The restricting member 11 urges the spring 10 and restricts the movement of the spring with respect to the direction of the rotational axis of the spring 10.

### [Spring]

A configuration of the spring 10 will be described by using part (a) and part (b) of FIG. 4. Part (a) of FIG. 4 is a top view of the spring 10 when it is viewed in a direction of an imaginary vertical line T (see part (b) of FIG. 4) of an annular shape portion 12 which will be described below, and part (b) of FIG. 4 is a side view of the spring 10. Incidentally, the imaginary vertical line T is in a same direction as a direction of a rotational axis of the rotating shaft 8 when the spring 10 is mounted on a scanner motor 1. The spring 10 which is an urging member in the first embodiment, includes the annular shape portion 12 which includes an annular shaped surface 12b which abuts with the rotatable polygon mirror 3, and a plurality of arm portions 13 which are formed integrally with the annular shape portion 12. The arm portions 13 extend radially from an outer shape portion 12a which is an outer periphery of the annular shape portion 12, and are provided at equal intervals with respect to a rotational direction around a rotational center of the rotatable polygon mirror 3. The arm portion 13 includes a first portion 13d, a bent portion 13a and a second portion 13e.

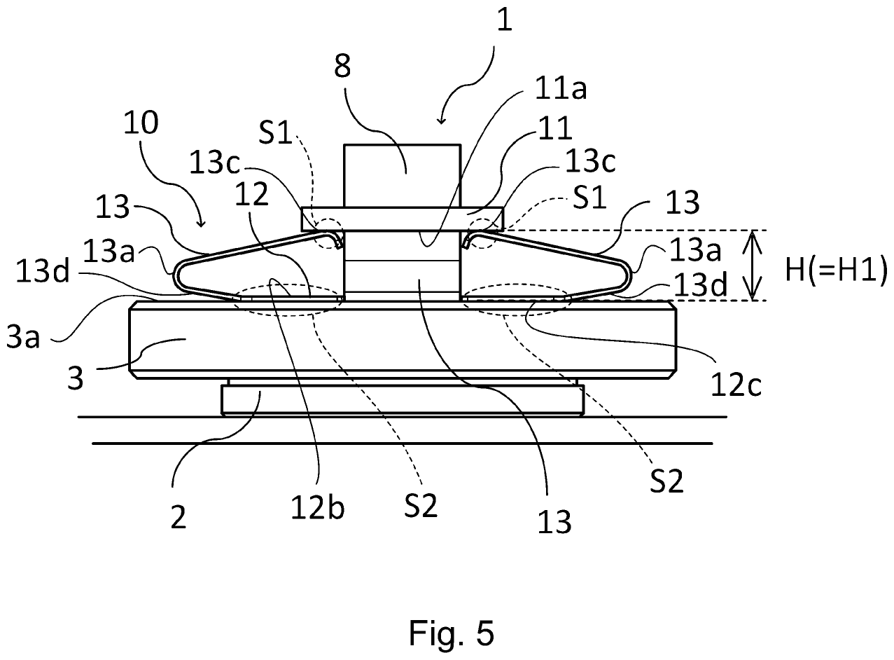

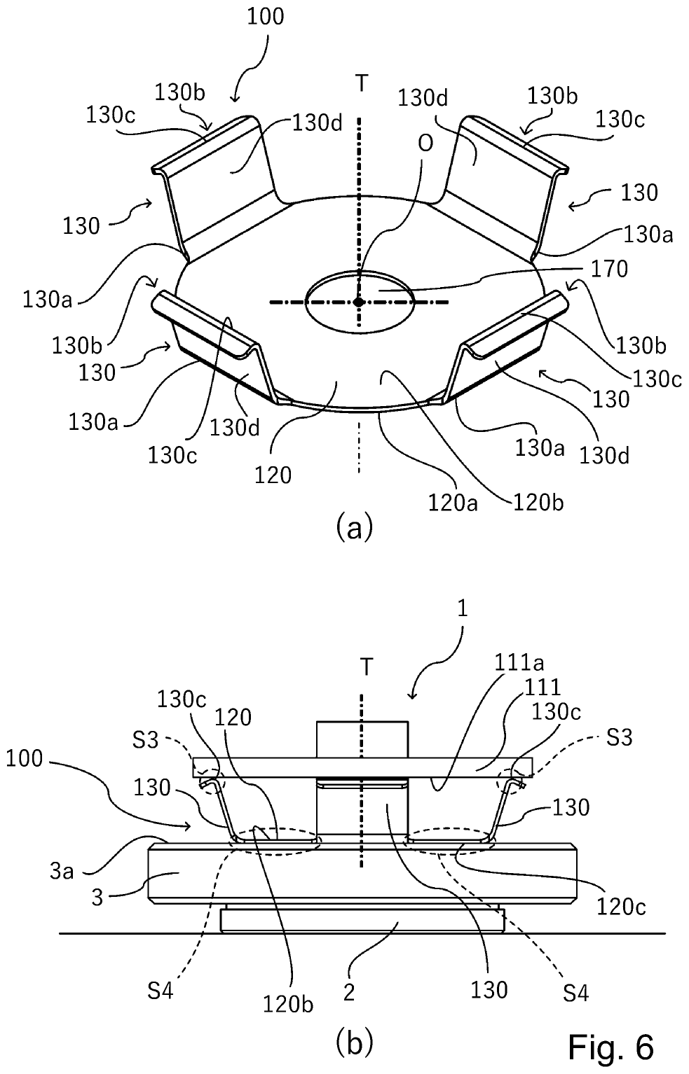

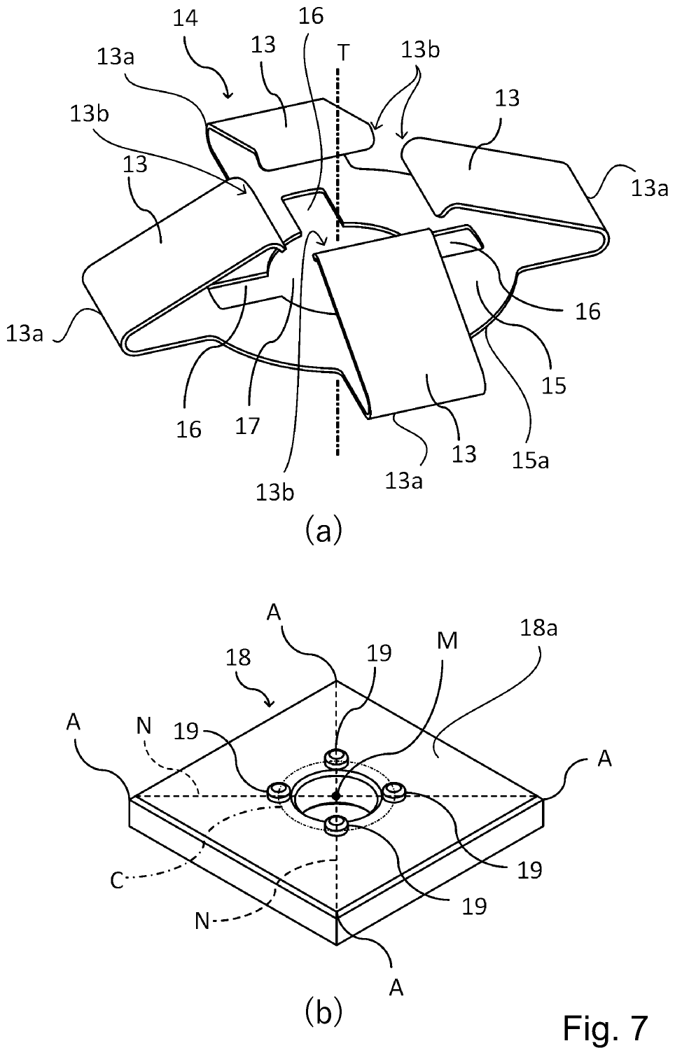

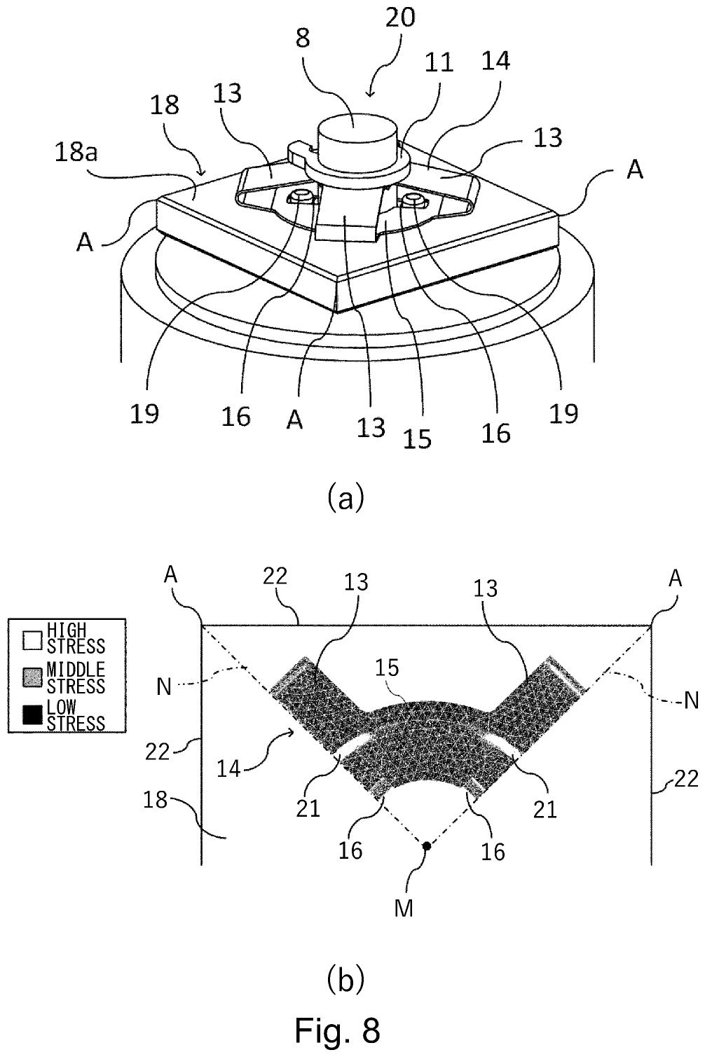

The first portion 13d extends from the outer periphery of the annular shape portion 12. The bent portion 13a is continuous from the first portion 13d and bends so that the arm portion 13 is away from the annular shaped surface 12b of the annular shape portion 12 with respect to the direction of the rotational axis and is toward the rotational center. The second portion 13e is continuous from the bent portion 13a and extends so that the second portion 13e is away from the annular shaped surface 12b of the annular shape portion 12 with respect to the direction of the rotational axis and is toward the rotational center. A leading end portion 13b of the second portion 13e abuts the restricting member 11. The first portion 13d does not abut a top surface 3a of the rotatable polygon mirror 3 (see FIG. 5) which the annular shape portion 12 abuts, while the spring 10 is urged by the restricting member 11.

The spring 10 is manufactured by punching and bending of a metal plate. The spring 10 includes the annular shape portion 12 in which a through hole 17 is formed and four pieces of the arm portions 13. The arm portion 13 extends outward (in other words, in a radial direction) from a center O of the annular shape portion 12, equally spaced and radially spaced from the annular shape portion 12, and is bent and raised toward the imaginary vertical line T which passes through the center O of the annular shape portion 12. That is, the arm portion 13 includes the bent portion 13a. The leading end portion 13b of the arm portion 13 is formed so that it is located inside the outer shape portion 12a (outer shape) (outer periphery) of the annular shape portion 12 which is projected in a direction of the imaginary vertical line T. Furthermore, the leading end portion 13b includes a bent portion 13c which bends toward the annular shape portion 12.

Further, width and length of each of the arm portions 13 are equal, and each of apexes of the arm portions 13, in other words, the bent portions 13c, has equal height H from the annular shape portion 12. In part (a) and part (b) of FIG. 4, four pieces of the arm portions 13 are provided at equal intervals, for example, they are spaced at 90 degrees around the center O.

### [Fixing of Rotatable Polygon Mirror by Spring]

A method how to fix the rotatable polygon mirror 3 to the pedestal 2 will be described by using FIG. 5. FIG. 5 is a side view of the rotatable polygon mirror 3 in the deflector 1 while the rotatable polygon mirror 3 is fixed. When the rotatable polygon mirror 3 is fixed by the spring 10, the annular shape portion 12 is abutted against the top surface 3a of the rotatable polygon mirror 3 while the through hole 17 of the annular shape portion 12 which is not shown in FIG. 5 is substantially engaged with the rotating shaft 8. After that, the restricting member 11 is fixed to the rotating shaft 8. A movement of the spring 10 in the direction of the rotational axis is restricted when the arm portion 13 which is bent and raised, specifically the bent portion 13c of the arm portion, is abutted against the restricting portion 11 which is secured to the rotating shaft 8.

And the arm portion 13 is elastically deformed by setting a position of the restricting member 11 so that the height H of the apex of the arm portion 13 (the bent portion 13c) from the annular shaped surface 12b of the annular shape portion 12 is lower than an initial state. Here, when an initial height H which is shown in part (b) of FIG. 4 is defined as H0 and a height H in a state which is restricted by the restricting member 11 which is shown in FIG. 5 is defined as H1, it becomes H1<H0.

By doing so, a repulsive force is generated in an abutting portion S1 between the spring 10 and the restricting member 11 and an abutting portion S2 between the spring 10 and the rotatable polygon mirror 3, respectively. Here, the abutting portion S1 is a portion in which the leading end portion 13b (the bent portion 13c) of the spring is abutted against a surface 11a of the restricting member 11. The abutting portion S2 is a portion in which a surface 12c which is in an opposite side of a surface 12b in the annular shape portion 12 of the spring 10 is abutted against the top surface 3a of the rotatable polygon mirror 3.

Since the restricting member 11 is secured to the rotating shaft 8, the annular shape portion 12 urges the rotatable polygon mirror 3 by the repulsive force and the rotatable polygon mirror 3 is fixed to the pedestal 2. At that time, the first portion 13d of the arm portion 13, which is formed in the same plane as the annular shape portion 12, is separated from the rotatable polygon mirror 3 by a moment force, and only the annular shape portion 12 urges the rotatable polygon mirror 3. Here, the first portion 13d of the arm portion 13 is a portion between the annular shape portion 12 and the bent portion 13a of the arm portion 13.

In this way, the arm portion 13 includes the first portion 13d which extends from the outer periphery of the annular shape portion 12. Further, the arm portion 13 includes the bent portion 13a which is continuous from the first portion 13d and bends so that the arm portion 13 is away from the annular shaped surface 12b of the annular shape portion 12 with respect to the direction of the rotational axis and is toward the rotational center. Furthermore, the arm portion 13 includes the second portion 13e which is continuous from the bent portion 13a and extends so that the second portion 13e is away from the annular shaped surface 12b of the annular shape portion 12 with respect to the direction of the rotational axis and is toward the rotational center. And the leading end portion 13b of the second portion 13e abuts the restricting member 11. And the first portion 13d does not abut the top surface 3a in which the rotatable polygon mirror 3 abuts the annular shaped surface 12b of the annular shape portion 12, while the spring 10 is urged by the restricting member 11.

### Effect

According to the first embodiment, it is possible to obtain effects which will be described below when the configuration, which is described above, for the fixing method of the rotatable polygon mirror 3 is applied. Between the annular shape portion 12 of the spring and the rotatable polygon mirror 3, the annular surface 12c of the annular shape portion 12 and the top surface 3a of the rotatable polygon mirror are surface contacted. When an urging force is applied to the spring 10, the annular shape portion 12 which abuts the rotatable polygon mirror 3 is not substantially displaced with respect to a radial direction of the rotatable polygon mirror 3. Therefore, it is possible to urge the rotatable polygon mirror 3 almost only in the direction of the rotational axis.

Further, the urging force of the spring 10 acts on the annular shape portion 12 by the arm portions 13, which are formed at equal intervals in the same number as the number of the reflecting surfaces of the rotatable polygon mirror 3. In the first embodiment, the number of reflecting surfaces of the rotatable polygon mirror 3 is four, and the number of the arm portions 13 is also 4 as same number. Therefore, the urging force of the spring 10 acts equally on the reflecting surfaces of the rotatable polygon mirror 3. In this way, it is possible to minimize the deformation of the reflecting surface of the rotatable polygon mirror 3 and also suppresses variation in the deformation of each surface.

Furthermore, when the annular shape portion 12 is substantially engaged with the rotating shaft 8, it is possible to suppress deviation of the rotatable polygon mirror 3 with respect to a radial direction. In this way, it is possible to suppress distortional deformation of the rotatable polygon mirror 3, since the urging force which acts on the rotatable polygon mirror 3 suppresses eccentricity with respect to the rotating shaft 8.

From the above, it is possible to suppress the deformation of each reflecting surface of the rotatable polygon mirror 3 by the urging force of the spring 10 and also equalizes the deformation amount of each reflecting surface. That is, it is possible to fix the rotatable polygon mirror 3 to the pedestal 2 more accurately, and it is possible to obtain high definition images.

Incidentally, the spring 10 is mounted so that the arm portion 13 is positioned on a diagonal line of the rotatable polygon mirror 3, as shown in FIG. 2. More specifically, the spring 10 is mounted so that the arm portion 13 is positioned on an imaginary line which connects the rotational center of the rotatable polygon mirror 3 and each apex of the rotatable polygon mirror 3. Here, the apexes of the rotatable polygon mirror are apexes of a square in a case that the rotatable polygon mirror includes four reflecting surfaces, and apexes of a pentagon in a case that it includes five reflecting surfaces, and boundary portions between the reflecting surface and the adjacent reflecting surface.

### [Modified Example of Spring]

Modified example of the first embodiment will be described by using FIG. 6. Part (a) of FIG. 6 is a perspective view of the spring 100 showing the modified example. Part (b) of FIG. 6 is a side view of the fixing portion of the rotatable polygon mirror 3 in the deflector 1 showing the modified example. An arm portion 130 of the spring 100 according to the modified example of the first embodiment includes a bent portion 130a and a portion 130d. The bent portion 130a is continuous from an outer periphery (outer shape portion 120a) of an annular shape portion 120 and bends so that the arm portion 130 is away from an annular shaped surface 120b of the annular shape portion 120 with respect to a direction of a rotational axis and is away from a rotational center. The portion 130d is continuous from the bent portion 130a and extends so that the portion 130d is away from the annular shaped surface 120b of the annular shape portion 120 with respect to the direction of the rotational axis and is away from the rotational center. A leading end portion 130b of the portion 130d abuts a restricting member 111.

The spring 100 is integrally manufactured, for example, by punching and bending metal plate, etc. and is configured of the annular shape portion 120 in which a through hole 170 is formed and four pieces of the arm portions 130. The arm portions 130 extend at equal intervals and radially from the annular shape portion 120, and are bent and raised toward the imaginary vertical line T which passes through a center O of the annular shape portion 120. Further, the arm portion 130 is not formed on the same plane as the annular shape portion 120, and is bent and raised near the outer shape portion 120a (outer periphery). That is, the arm portion 130 includes the bent portion 130a. Furthermore, the leading end portion 130b of the arm portion 130 includes a bent portion 130c which bends toward a direction which is away from the center O of the annular shape portion 120.

When securing the rotatable polygon mirror 3 with the spring 100, the annular shape portion 120 is abutted against the top surface 3a of the rotatable polygon mirror 3 while the through hole 170 of the annular shape portion 120 is substantially engaged with the rotating shaft 8. A movement of the spring 100 with respect to the rotational axis is restricted when the arm portion 130 which is bent and raised, specifically, the bent portion 130c of the arm portion 130, is abutted against the restricting member 111 which is secured to the rotating shaft 8. And the arm portion 130 is elastically deformed by setting a position of the restricting member 111 so that a height of the apex of the arm portion 130 (the bent portion 130c) from the annular shaped surface 120b of the annular shape portion 120 is lower than an initial state.

By doing so, repulsive forces are generated in an abutting portion S3 between the spring 100 and the restricting member 111 and in an abutting portion S4 between the spring 100 and the rotatable polygon mirror 3, respectively. Here, the abutting portion S3 is a portion in which the leading end portion 130b of the spring 100 is abutted against a surface 111a of the restricting member 111. The abutting portion S4 is a portion in which a surface 120c which is in an opposite side of the surface 120b is abutted against the top surface 3a of the rotatable polygon mirror 3.

Width and length of each of the arm portions 130 are equal, and each of apexes of the arm portions 130 (the bent portions 130c) which are bent and raised, is equal height from the annular shape portion 120. And the annular shape portion 120 abuts the rotatable polygon mirror 3, and when the restricting member 111 urges the arm portion 130, the rotatable polygon mirror 3 is fixed to the pedestal 2.

In this way, the bent portion 130 according to the modified example is continuous from the outer periphery of the annular shape portion 120 and bends so that the arm portion 130 is away from the annular shaped surface 120b of the annular shape portion 120 with respect to the direction of the rotational axis and is away from the rotational center. Further, the arm portion 130 includes the portion 130d which is continuous from the bent portion 130a and extends so that the portion 130d is away from the annular shaped surface 120b of the annular shape portion 120 with respect to the direction of the rotational axis and is away from the rotational center. The leading end portion 130b of the portion 130d abuts the restricting member 111.

Even in the configuration which is described above, it is possible to urge the rotatable polygon mirror 3 only by the annular shape portion 120, and it is possible to obtain the same effect as the first embodiment which is described above. Furthermore, an amount of the arm portion 130 is reduced, improving the workability of the spring 100.

Incidentally, the number of each of the arm portions 13 and the arm portions 130 is set to four in the first embodiment, however, it is not limited to this, as the deformation amount of each reflecting surface of the rotatable polygon mirror 3 may be equal. The number of each of the arm portions 13 and the arm portions 130 may be, for example, a multiple of the number of the reflecting surfaces of the rotatable polygon mirror 3. That is, the plurality of the arm portions 13 and the arm portions 130 should be provided an integer multiple of the number of the reflecting surfaces of the rotatable polygon mirror 3.

In this way, since the spring, which is an urging member, urges the rotatable polygon mirror equally only in the direction of the rotational axis, the distortional deformation of the rotatable polygon mirror is suppressed, and even when each of the reflecting surface of the rotatable polygon mirror is deformed, the deformation amount is substantially equal. Thus, since difference in accuracy of the reflecting surfaces among the surfaces is reduced, it is possible to fix the rotatable polygon mirror more accurately and more stably fixed to the pedestal, and it is possible to suppress occurring the jitter, the surface inclination, etc. and obtain higher definition images.

As described above, according to the first embodiment, it is possible to fix the rotatable polygon mirror more accurately and more stably to the pedestal, and it is also possible to suppress occurring the jitter, the surface inclination, etc.

### Second Embodiment

### [Spring]

The second embodiment will be described. Incidentally, the same reference numerals will be added for the same parts as the configuration which described in the first embodiment, and descriptions will be omitted. By using part (a) of FIG. 7, a configuration of the spring 14 which fixes the rotatable polygon mirror 18 will be described. Part (a) of FIG. 7 is a perspective view of the spring 14. The rotatable polygon mirror 18 according to the second embodiment includes a plurality of protrusion portions 19 which position the arm portions 13 of the spring 14 on a top surface 18a which opposes an abutting portion 15 of the spring 14 according to the second embodiment. The abutting portion 15 of the spring 14 includes a plurality of notched portions 16 which are engaged with the plurality of protrusion portions 19. That is, an annular shaped inner periphery of the spring 14 is notched toward an outer periphery. The plurality of the protrusion portions 19 are provided on an imaginary circle (C, which will be described below) which is centered on a rotational center of the rotatable polygon mirror 18 and provided on an imaginary line (N, which will be described below) which connects a vertex A of a shape of the rotatable polygon mirror 18 when the rotatable polygon mirror 18 is viewed in the direction of the rotational axis and the rotational center of the rotatable polygon mirror 18.

The spring 14 is integrally formed, for example, by punching and bending metal plate, etc. and is configured of the abutting portion 15 whose outer shape is circle and four pieces of the arm portions 13. In the abutting portion 15, the through hole 17 and the notched portions 16 whose phases are aligned with directions in which the arm portions 13 extend radially are formed. The arm portions 13 extend at equal intervals and radially from the abutting portions 15, and are bent and raised toward the imaginary vertical line T which passes through the center O of the abutting portion 15, which is not shown in part (a) of FIG. 7. That is, the arm portion 13 includes the bent portion 13a. Width and length of each of the arm portions 13 are equal, and each of apexes of the arm portions 13, in other words, the bent portions 13c, has equal height H from the abutting portion 15.

### [Shape of Rotatable Polygon Mirror]

A shape of the rotatable polygon mirror 18 will be described by using part (b) of FIG. 7. Part (b) of FIG. 7 is a perspective view of the rotatable polygon mirror 18. The rotatable polygon mirror 18 according to the second embodiment is, for example, a resin molded product, and the protrusion portions 19 are integrally molded and provided on the top surface 18a. The protrusion portions 19 are placed at equal intervals (for example, 90 degrees spacing) on a concentric circle C of a center M of the rotatable polygon mirror 18 within the top surface 18a of the rotatable polygon mirror 18, and placed on the line N which connects the center M and the four vertexes A of the rotatable polygon mirror 18, respectively.

### [Fixing of Rotatable Polygon Mirror by Spring]

A method how to fix the rotatable polygon mirror 18 by the spring 14 will be described by using part (a) of FIG. 8. Part (a) of FIG. 8 is a perspective view showing a state that the rotatable polygon mirror 18 is fixed to a deflector 20. When the rotatable polygon mirror 18 is fixed by the spring 14, the through hole 17, which is not shown in part (a) of FIG. 8, is substantially engaged with the rotating shaft 8, a phase of the spring 14 is aligned by the notched portions 16 and the protrusion portions 19, and an abutting portion 15a (see part (a) of FIG. 7) of the abutting portion 15 is abutted against the top surface 18a of the rotatable polygon mirror 18. In this case, the phase is that the arm portions 13 are directed toward the vertexes A of the rotatable polygon mirror 18. In this state, the restricting member 11 is mounted in the same way as in the first embodiment, and the rotatable polygon mirror 18 is fixed to the pedestal 2.

### Effect

An effect, in a case that the arm portion 13 is arranged in a phase in which the arm portion 13 is directed in a direction of the vertexes A of the rotatable polygon mirror 18, will be described by using part (b) of FIG. 8. Part (b) of FIG. 8 is a view showing one of four equal areas of the spring 14 and a diagram of a stress distribution of the abutting portion 15 and the spring 14 when it is seen from a side of the top surface 18a of the rotatable polygon mirror 18. In the figure, white indicates areas of high stress, black indicates areas of low stress, and gray indicates areas of middle stress.

The spring 14 urges the rotatable polygon mirror 18 when the arm portion 13 is elastically deformed, so urging force (stress) is the greatest in a root 21 of the arm portion 13. When the arm portion 13 is positioned in the direction of the vertexes A of the rotatable polygon mirror 18, the root 21 is the farthest away from a reflecting surface 22 of the rotatable polygon mirror 18. It is possible to suppress deformation of the reflecting surface 22 by the urging force of the spring 14, since the root 21, which has the greatest urging force, is away from the reflecting surface 22.

Incidentally, it may not be limited to the second embodiment, the notched portion 16 and the protrusion portion 19 may be formed in such a position that the arm portion 13 extends toward the vertexes A of the rotatable polygon mirror 18. Further, the notched portion 16 and the protrusion portion 19 are possible to apply to the modified example of the first embodiment.

Further, since the rotatable polygon mirror 18 is the molded resin product, when the protrusion portions 19 are formed at equal intervals on concentric circle of the center M of the rotatable polygon mirror 18 and in the same number as the number of the reflecting surfaces 22, it is possible to equalize resin flow to each reflecting surface during molding the rotatable polygon mirror 18. Thus, it is possible to mold the rotatable polygon mirror 18 with high accuracy. In the second embodiment, it is possible to realize improvement of image forming performance, since it is possible to mold the rotatable polygon mirror 18 with high accuracy and reduce deformation when it is mounted on the deflector 20.

As described above, according to the second embodiment, it is possible to fix the rotatable polygon mirror more accurately and more stably to the pedestal, and it is also possible to suppress occurring the jitter, the surface inclination, etc.

In the first embodiment and the second embodiment, four of the arm portions 13 or four of the arm portions 130 have the same width, however, they are not limited to this. For example, two of the arm portions 13 or two of the arm portions 130 which oppose each other across the through hole 17 or the through hole 170 need only be the same width, and the widths of the adjacent arm portions 13 or the adjacent arm portions 130 may be different. Here, the width of the arm portion 13 or the arm portion 130 is defined as a length of the arm portion 13 or the arm portion 130 in a direction which is perpendicular to a direction in which the arm portion 13 or the arm portion 130 extends.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-151927 filed on Sep. 22, 2022, which is hereby incorporated by reference herein in its entirety.

What is claimed is:

1. An optical deflector comprising:
a rotatable polygon mirror including a plurality of reflecting surfaces for reflecting light;
a driving unit configured to drive the rotatable polygon mirror;
an urging member configured to urge the rotatable polygon mirror toward the driving unit to fix the rotatable polygon mirror to the driving unit; and
a restricting member configured to press the urging member and restrict movement of the urging member with respect to a rotational axis direction of the rotatable polygon mirror,
wherein the urging member includes an annular shape portion having an annular shape surface contacting the rotatable polygon mirror and a plurality of arm portions integrally formed with the annular shape portion, and
wherein the plurality of the arm portions radially extend from an outer circumference of the annular shape portion, are disposed at equal intervals with respect to a rotational direction with a rotation center of the rotatable polygon mirror, and are pressed by the restricting member.

2. An optical deflector according to claim 1, wherein the plurality of the arm portions are provided by an integer multiple of a number of the reflecting surfaces.

3. An optical deflector according to claim 1, wherein the rotatable polygon mirror includes a plurality of protrusion portions for positioning the arm portions on a surface opposite to the annular shape portion, and
wherein the annular shape portion includes a plurality of cutaway portions for engaging with the plurality of the protrusion portions, respectively, at a position of the same phase as the arm portions.

4. An optical deflector according to claim 3, wherein the plurality of the protrusion portions are disposed on an imaginary circle with the rotation center of the rotatable polygon mirror, on an imaginary line connecting a vertex between two of the reflecting surfaces adjacent to each other of the plurality of the reflecting surfaces and the rotation center of the rotatable polygon mirror.

5. An optical deflector according to claim 4, wherein the rotatable polygon mirror is formed of a resin.

6. An optical deflector according to claim 1, wherein each of the arm portions includes
a first portion extending from the outer circumference of the annular shape portion,
a bent portion continuing from the first portion and configured to bent the arm portion so as to be away from the annular shape surface of the annular shape portion in the rotational axis direction and toward the rotation center, and
a second portion continuing from the bent portion and configured to extend away from the annular shape surface of the annular shape portion in the rotational axis direction and toward the rotation center,
wherein a tip portion of the second portion is positioned inside of the outer circumference in a radial direction based on the rotation center and contacts the restricting member.

7. An optical deflector according to claim 6, wherein in a state in which the urging member is pressed by the restricting member, the first portion is away from the rotatable polygon mirror in the rotational axis direction.

8. An optical deflector according to claim 1, wherein each of the arm portions includes
a bent portion continuing from the outer circumference of the annular shape portion and configured to bent the arm portion so as to be away from the annular shape surface of the annular shape portion in the rotational axis direction and toward the rotation center, and
a portion continuing from the bent portion and configured to extend so as to be away from the annular shape surface of the annular shape portion in the rotational axis direction and away from the rotation center in a radial direction based on the rotation center,
wherein a tip portion of the portion contacts the restricting member.

9. A scanning optical device comprising:
a light source configured to emit a laser light; and
an optical deflector according to claim 1, the optical deflector deflecting the laser light emitted from the light source.

10. An image forming apparatus comprising:
an image bearing member;
a scanning optical device according to claim 9, the scanning optical device being configured to scan the image bearing member with a laser light and form an electrostatic latent image; and
an image forming unit configured to develop the electrostatic latent image with toner and form a toner image on the image bearing member, and then to transfer the toner image to a recording material and form the toner image on the recording material.
